(19) United States
(12) Patent Application Publication
(10) Pub. No.: US 2008/0252685 A1
(43) Pub. Date: Oct. 16, 2008

(54) Web for printhead

(76) Inventors: Antonio Gomez, Vancouver, WA (US); Jena Marie Klees, Vancouver, WA (US); Mark D. Groenenboom, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/787,355

(22) Filed: Apr. 16, 2007

(51) Int. Cl. B41J 2/165; B41J 29/38

(52) U.S. Cl. 347/33; 347/9

(57) ABSTRACT

Various embodiments of a web for a printhead are disclosed.

### BACKGROUND

Printheads are used to deposit ink upon media. During use, printheads are sometimes serviced with such operations as spitting and wiping. Those components of printers used for servicing the printheads sometimes fail and cause the printer to stop working.

### BRIEF DESCRIPTION OF THE DRAWINGS

FIG. 1 is a schematic illustration of a printing system according to one exemplary embodiment.

FIG. 2 is a sectional view of a printing system according to one exemplary embodiment.

FIG. 3A is a block diagram of a printing system with a large feed spool according to one embodiment.

FIG. 3B is a block diagram of a printing system with a small feed spool according to one embodiment.

FIG. 4 is a flow diagram for determining web amount according to one exemplary embodiment.

FIG. 5 is a block diagram showing a printer according to one exemplary embodiment.

### DETAILED DESCRIPTION

Exemplary embodiments are directed to apparatus, systems, and methods for determining web level for a web fabric based service station cartridge in a printer. One embodiment provides a method to evaluate or monitor movement of a web fabric to estimate the web level of the web fabric remaining in a service station. The web level is provided and communicated to a user to reduce printing and copying downtime that occurs when the web becomes used or depleted.

One embodiment tracks the amount of web remaining in a replaceable web cartridge by keeping count of web drive encoder counts per web advance. As a result, the level of web can be estimated at any time a web advance is performed by looking at the number of web drive encoder counts necessary to complete a web advance. In one embodiment, a web advance is a distance that the web fabric advances to place clean web fabric for printhead servicing.

The web level estimate can be communicated to a user (such as a customer or technician). For instance, a person can query the web level at any time to determine whether an existing web cartridge should be replaced with a new one or not. Customers can keep track of the web level remaining for servicing printheads. Based on the web level reported and historical printing of a unit, the customer can request that the web cartridge be replaced to prevent unit downtime. A person can also query the web level at any time and determine when to replace the web cartridge. This query can be performed at the unit (example, through a graphical user interface) or from a remote location (such as a computing device in communication with the unit).

In one embodiment, one or more printheads are serviced with the web. As used herein, “service” or “servicing” means to provide maintenance for an object. Servicing a printhead includes, but is not limited to, spitting and wiping the printhead to maintain optimum printhead operation and optimum printing quality. In one embodiment, the web cartridge services one or more printheads in order to maintain operation of a printing device. One embodiment is a method for calculating the web level of a web fabric based service station so the web fabric is available to service printheads.

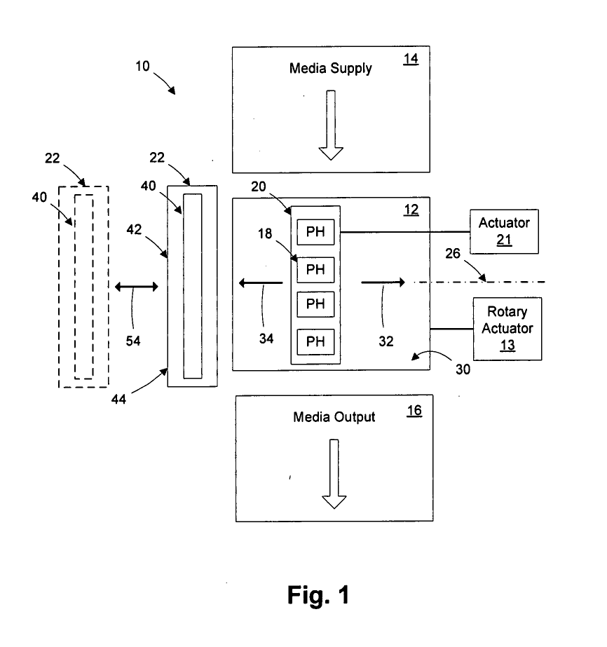

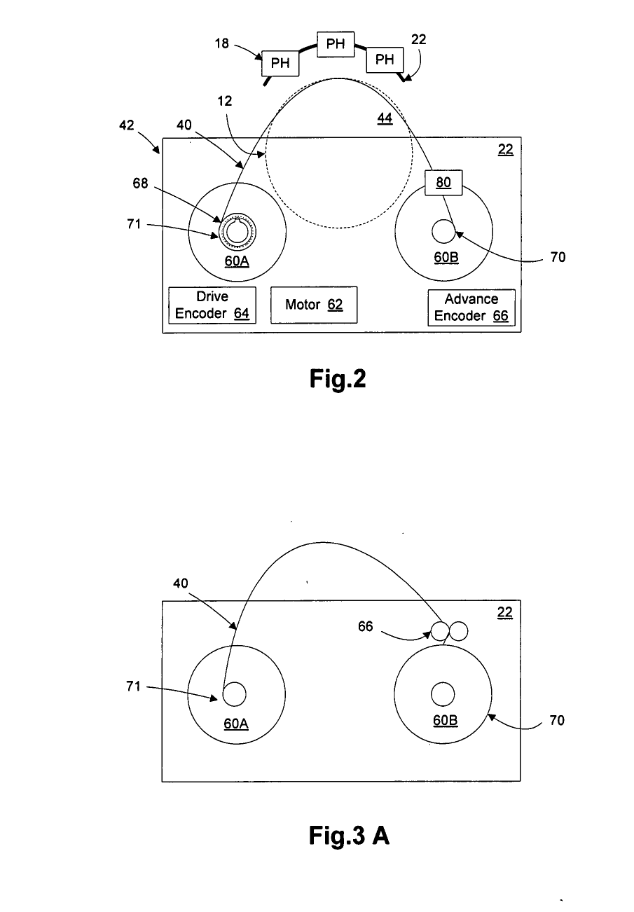

FIGS. 1 and 2 schematically illustrate a printing system 10 according to one or more exemplary embodiments. Printing system 10 generally includes drum 12, rotary actuator 13, media supply 14, media output 16, printheads 18, carriage 20, actuator 21, and web service station 22. Drum 12 generally comprises an elongated cylinder configured to be rotatably driven about axis 26 by rotary actuator 13 while transporting media, such as paper, about axis 26 relative to printheads 18. Rotary actuator 13 comprises a source of torque, such as a motor, operably coupled to drum 12 by a transmission (not shown).

Media supply 14, schematically shown, comprises a mechanism configured to supply media to drum 12. In one embodiment, media supply 14 comprises a mechanism configured to pick an individual sheet of media from a stack of media and to supply the individual sheet to drum 12 such that the sheet is wrapped at least partially about drum 12. Media output 16, schematically shown, comprises a mechanism to withdraw printed media from drum 12 and to transport withdrawn media to and contain withdrawn media within an output tray, bin or the like.

Printheads 18 comprise printheads configured to dispense imaging material, such as ink, upon the medium held by drum 12. In one embodiment, printheads 18 are arranged in an arc about axis 26. Drum 12 has an outer surface 30 also arranged in an arc about axis 26. Although system 10 is illustrated as including four printheads in FIG. 1 and three in FIG. 2 supported by a single carriage 20, the number of printheads and configuration with respect to the carriage can vary. For example, system 10 can alternatively include a greater or fewer number of such printheads 18 supported by one or more carriages 20 regardless of whether the printheads and carriages are in an curved, linear, or other configuration.

Carriage 20 comprises one or more structures configured to support printheads 18 in the arcuate arrangement. In addition, carriage 20 is configured to movably support printheads 18 along axis 26. Actuator 21 comprises a linear actuator configured to move carriage 20 and printheads 18 in the directions indicated by arrows 32, 34 so as to selectively position printheads 18 opposite to the media held by drum 12 or opposite to service station 22. In one embodiment, actuator 21 comprises a motor.

Service station 22 comprises a station located on an axial end of drum 12 such that carriage 20 may position printheads 18 opposite, or adjacent, to station 22. Station 22 includes one or more components configured to perform servicing operations upon one or more of the printheads 18. As shown by FIG. 1, service station 22 includes one or more webs 40 of material for performing servicing operations upon printheads 18. For instance, the service station can include two independent web feed spools (such as a wipe web spool and a spit web spool) or one single web spool with one single web used for both wiping and spitting the printheads. For ease of illustration, a single web 40 is shown, but exemplary embodiments include multiple webs for servicing printheads 18.

In one embodiment, web 40 is configured to interact with printheads 18 by receiving printing material or ink discharged from printheads 18. For example, in one embodiment, printheads 18 include multiple nozzles. Web 40 facilitates spitting of ink from the nozzles to clear such nozzles. In one embodiment, web 40 comprises a web of fluid absorbent material and/or a fabric material. In one embodiment, web 40 comprises an elongate band of material configured to perform a distinct servicing operation upon printheads 18, such as contacting and wiping the printheads

As shown by FIG. 2, in the particular example shown, service station 22 further includes a housing 42 and a track 44. Housing 42 comprises one or more walls, panels, structures and the like configured to support track 44 and web 40 relative to drum 12. In one embodiment, service station 22 is configured to be inserted adjacent to or removed from drum 12 as indicated by arrows 54. The service station 22 shown in dashed lines indicates it being removed from or inserted into the printing system. The removability of service station 22 facilitates replacement, repair, refurbishment, or refilling of the unit and/or components thereof. For example, when web 40 becomes sufficiently saturated with printing material or ink from printheads 18, service station 22 can be removed and either replaced with an entirely new cartridge or be refilled with another one of web 40.

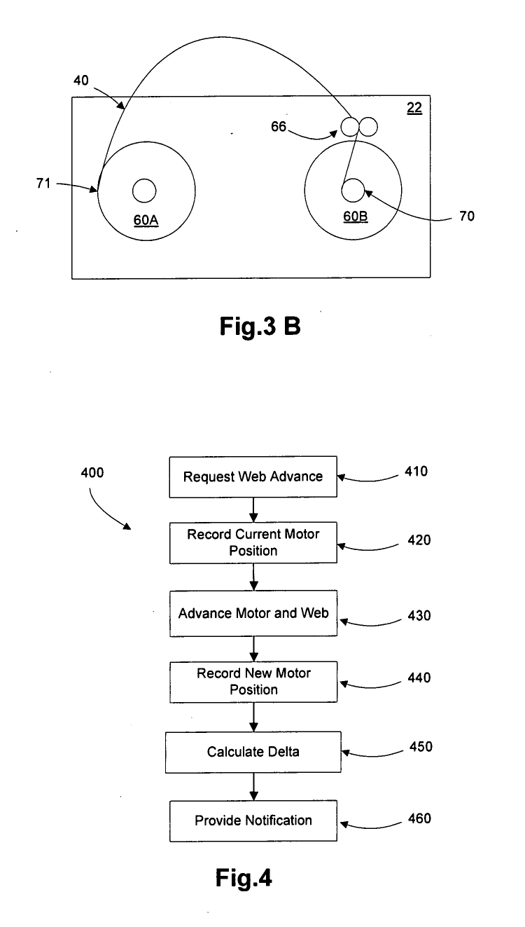

As best shown in FIG. 2, the service station 22 includes two spool chambers 60A and 60B, a web drive motor 62, drive encoder 64, and advance encoder 66. Spool chamber 60A includes a roller and one or more gears 68 rotatable upon actuation from web drive motor 62. In one embodiment, spool chamber 60B supplies web 40 from a roller 70 to spool chamber 60A. Initially, web roller 70 is large but as the printheads 18 are serviced and web fabric advanced and transferred to spool chamber 60A, web roller 70 becomes smaller and drive roller 71 becomes larger. For example, FIG. 3A shows a large or full roller 70 with roller 71 having a smaller amount of web 40. FIG. 3B shows a small or near empty roller 70 with roller 71 having a larger amount of web 40.

In one embodiment, to service the printheads 18, clean web 40 is positioned underneath the printheads 18. After the printheads 18 are serviced, namely wiped and/or spat, the web 40 is advanced a constant distance by the web drive motor 62 with a closed loop feedback by the web advance encoder 66. The web fabric is wrapped around a web roller 70 and the distance of advancement is measured by looking at the roller rotation which is equipped with the web advance encoder 66 (see FIGS. 3A and 3B for example position of the advance encoder). As a web advance is executed, the web drive motor 62, equipped with an independent web drive encoder 64, sees a certain number of web drive encoder counts per web advance needed to fully spool the web. Initially, when the web drive spool chamber 60A is nearly empty (see FIG. 3A), the web drive motor 62 has to rotate more and sees more web drive encoder counts per web advance. As web is consumed and advanced, the web drive motor 62 rotates less since more web is located in spool chamber 60A (see FIG. 3B). The number of web drive encoder counts per web advance decreases rapidly.

In one embodiment, the web service cartridge 22 includes two independent web feed spools: wipe and spit web spools. In one embodiment, the wipe web is the web fabric being encoded. The spit web is automatically pulled and spooled as the wipe web is advanced. In one embodiment, web lengths are specified to ensure that the web service cartridge 22 is equipped with the proper web lengths to ensure that the spit web is not depleted before the wipe web.

One embodiment includes a mechanism 80 to ensure that the spit web and wipe web are spooled with a consistent tension (such as the same tension). By way of example, the mechanism includes tensioning sheet metal fingers to provide the proper web drag so the spit web is spooled with the same tension as the wipe web. The wipe web tension is controlled using various mechanisms or devices, such as, but not limited to, rollers and biasing devices.

In one embodiment, web spooling tensions variations are minimized and/or eliminated. In one embodiment, the web drive spool diameter grows or enlarges at a constant rate.

FIG. 4 is a flow diagram 400 for determining web amount according to one exemplary embodiment. According to block 410, a request for web advance occurs. According to block 420, the current motor position is recorded. The motor advances the web for the request according to block 430. Next, the new motor position is recorded according to block 440. The difference between the initial motor position and the new motor position provides a delta according to block 450. Then, notification is provided according to block 460.

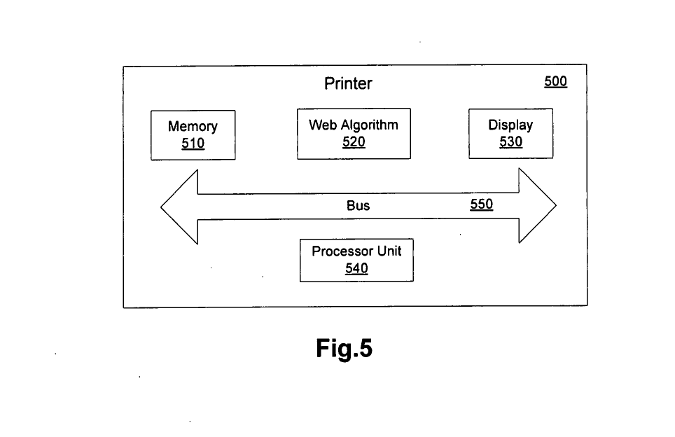

FIG. 5 is a block diagram showing a printer 500 according to one exemplary embodiment. The printer includes a memory 510, web algorithm 520, display 530, processing unit 540 and one or more buses 550.

In one embodiment, the processor unit includes a processor (such as a central processing unit, CPU, microprocessor, application-specific integrated circuit (ASIC), etc.) for controlling the overall operation of memory 510 (such as random access memory (RAM) for temporary data storage, read only memory (ROM) for permanent data storage, and firmware). The memory 510, for example, stores applications, data, programs, algorithms (including diagrams and methods discussed herein), and other data associated with the printer. The processing unit 540 communicates with memory 510 and display 530 via one or more buses 550.

In one exemplary embodiment, the current web level is visually displayed or presented on display 530. For instance, a user requests the web level and it is output at display 530. In another embodiment, the web level is automatically or periodically provided to the user (example, at display 530 or transmitted through one or more networks to a predetermined location).

In one embodiment, estimation of the web level provides information as to when a web cartridge should be serviced. Further, exemplary embodiments continue to provide a accurate estimation or indication of web level even if the web is manually advanced or a partially full web service cartridge is inserted into the printing system as long as a web advance is performed. For instance, one embodiment provides an accurate determination of web level after any manual web advancement and/or installation of a half-full or half-empty web cartridge. If the cartridge is furnished with the specified length of web material (example, specified in the design), the web level is accurately estimated regardless of any manual web advancement or web consumed.

In one embodiment, a user of the printer monitors service station cartridge web levels versus printing. When the cartridge level has reached a predetermined level or threshold (example, 75% used, 80% used, 85% used, etc.), the user can request a replacement service cartridge to prevent running out of web needed for maintaining printhead operation. Alternatively, when the cartridge level reaches a predetermined level or threshold, the level is automatically provided to the user (example, displayed on a display or transmitted to another computing device). One embodiment provides a user with visual, electronic, and/or audible notification upon reaching a predetermined threshold. By way of example, the notification indicates it is time to replace, repair, or service the web service cartridge.

In addition, field service personnel can query and/or monitor, even remotely, cartridge web level and determine when a cartridge replacement is necessary. For example, an estimate of the web level is electronically transmitted from the printing system to a remote location via one or more networks (such as one or more of the internet or an intranet).

Exemplary embodiments include a variety of methods for estimating the web level of a web fabric based service station cartridge. In one alternate embodiment for instance, acumen is added to each web cartridge so it is known that the web cartridge unit just installed is a new and full web cartridge. Life of a new cartridge is characterized based on the number of web advances and/or other counters. This embodiment could be configured to account for the fact that the web cartridge is a replaceable item and the web can be manually advanced by a field person and/or customer during servicing of the web cartridge and/or other printer components.

In one exemplary embodiment, one or more blocks or steps discussed herein are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments are provided as examples and should not be construed to limit other embodiments. For instance, blocks in diagrams or numbers (such as (1), (2), etc.) should not be construed as steps that must proceed in a particular order. Additional blocks/steps may be added, some blocks/steps removed, or the order of the blocks/steps altered and still be within the scope of the exemplary embodiments. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit embodiments.

Various embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, firmware, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments. Numerous variations and modifications will become apparent to those skilled in the art once the above disclosure is fully appreciated. It is intended that the following claims be interpreted to embrace all such variations and modifications.

What is claimed is:

1) An apparatus, comprising:
a web service cartridge having a web for servicing a printhead and a mechanism that measures a distance the web moves.

2) The apparatus of claim 1, wherein the mechanism includes an encoder for measuring rotation of a roller in the web service cartridge.

3) The apparatus of claim 1, wherein the mechanism includes a drive encoder for counting counts per advancements of the web.

4) The apparatus of claim 1, wherein the mechanism records information for determining a level of web fabric in the web service cartridge.

5) The apparatus of claim 1, further comprising a chamber in the web service cartridge, wherein the mechanism obtains information to track an amount of the web remaining in the chamber.

6) The apparatus of claim 1, further comprising a mechanism that provides a consistent tension on the web.

7) The apparatus of claim 1, wherein the web service cartridge includes two chambers for receiving the web, and the web cleans the printhead.

8) A method, comprising:
evaluating movement of a web inside a web service cartridge located in a printer to estimate a level of the web for a printhead.

9) The method of claim 8, further comprising using an encoder to record counts per movement of the web.

10) The method of claim 8, further comprising examining a number of encoder counts to complete an advancement of the web to estimate the level of web.

11) The method of claim 8, further comprising displaying an estimated level of the web on a display of the printer.

12) The method of claim 8, further comprising electronically transmitting an estimated level of the web to a location remote of the printer.

13) The method of claim 8, further comprising querying the printer to calculate and provide an estimated level of the web.

14) A computer readable medium having instructions for causing a computer to execute a method, comprising:
receiving information associated with movement of a web in a web service cartridge;
using the information to calculate a level of web for a printhead.

15) The computer readable medium of claim 14, wherein the information includes a distance that a roller moves during advancement of the web.

16) The computer readable medium of claim 14, wherein the information includes a number of counts an encoder determines during advancement of the web.

17) The computer readable medium of claim 14, wherein the information includes an amount of motorized rotation a roller experiences during a single advancement of the web.

18) The computer readable medium of claim 14, further comprising automatically displaying the level of the web when the level is at or above a predefined threshold.

19) The computer readable medium of claim 14, further comprising automatically providing a user with an audible notification when the level is at or above a predefined threshold.

20) The computer readable medium of claim 14, further comprising notifying a user before the level of web is depleted in the web service cartridge.
